(19) United States
(12) Patent Application Publication
(10) Pub. No.: US 2023/0011738 A1
(43) Pub. Date: Jan. 12, 2023

(54) VEHICLE DRIVING APPARATUS

(71) Applicant: TOYOTA JIDOSHA KABUSHIKI KAISHA, Toyota-shi (JP)

(72) Inventors: Hidetomo SHIOTA, Toyota-shi (JP); Gaku WATANABE, Anjo-shi (JP)

(73) Assignee: TOYOTA JIDOSHA KABUSHIKI KAISHA, Toyota-shi (JP)

(21) Appl. No.: 17/857,493

(22) Filed: Jul. 5, 2022

(30) Foreign Application Priority Data
Jul. 8, 2021 (JP) 2021-113818

(51) Int. Cl. B60K 7/00; H02K 9/19; H02K 1/32

(52) U.S. Cl. CPC B60K 7/0007; H02K 9/19; H02K 1/32

(57) ABSTRACT

A vehicle driving apparatus includes: a rotary shaft having an axial hole that opens in its axial end; a casing storing the rotary shaft; a bearing provided between the casing and the rotary shaft; and a lubrication mechanism for supplying an oil into an opening of the axial hole. The casing is provided with: a recessed portion defined by a wall surface of the casing and located on a side of the axial end of the rotary shaft, such that the axial end of the rotary shaft and the bearing are located in the recessed portion; an oil hole communicating with the recessed portion; and a projecting portion projecting from the wall surface toward the opening and having a distal end located inside the axial hole. The bearing, the wall surface and the projecting portion cooperate to surround a surrounded space that communicates with the opening of the axial hole.

This application claims priority from Japanese Patent Application No. 2021-113818 filed on Jul. 8, 2021, the disclosure of which is herein incorporated by reference in its entirety.

### FIELD OF THE INVENTION

The present invention relates to a structure of a lubrication mechanism provided in a vehicle driving apparatus.

### BACKGROUND OF THE INVENTION

There is known a vehicle driving apparatus that includes a rotary shaft having an axial hole which has an opening in an axial end of the rotary shaft and which extends from the axial end of the rotary shaft in an axial direction of the rotary shaft; a casing storing the rotary shaft therein; and a bearing disposed between the casing and an outer circumferential surface of the rotary shaft so as to rotatably support the rotary shaft. The vehicle driving apparatus includes a lubrication mechanism having a structure configured to supply an oil into the axial hole through the opening. As an example of such a lubrication mechanism, JP-2021-38822A discloses a lubrication structure in which a funnel-shaped oil guide is provided separately from the casing, such that the oil is to be supplied into the axial hole through the oil guide.

### SUMMARY OF THE INVENTION

By the way, in the lubrication structure disclosed by the above-identified Japanese Patent Application Publication, there is a problem that the number of components is increased and the assembly becomes complicated, due to the oil guide that is provided separately to guide the oil.

The present invention was made in view of the background art described above. It is therefore an object of the present invention to provide a vehicle driving apparatus including a lubrication mechanism configured to supply an oil into an axal hole of a rotary shaft through an opening of the axial hole which is provided in an axial end of the rotary shaft, wherein the vehicle driving apparatus is capable of efficiently causing an oil to flow into the axial hole, without increase of the number of components.

The above object is achieved according to the following aspects of the present invention.

According to a first aspect of the invention, there is provided a vehicle driving apparatus comprising: (a) a rotary shaft having an axial hole which has an opening in an axial end of the rotary shaft, and which extends from the axial end of the rotary shaft in an axial direction of the rotary shaft; (b) a casing storing the rotary shaft therein; (c) a bearing provided between the casing and an outer circumferential surface of the rotary shaft so as to rotatably support the rotary shaft; and (d) a lubrication mechanism having a structure configured to supply an oil into the opening of the axial hole, wherein the casing is provided with: (b-1) a recessed portion that is an annular space defined by a wall surface of the casing and located on a side of the axial end of the rotary shaft, such that the axial end of the rotary shaft and the bearing are located in the recessed portion; (b-2) an oil hole communicating with the recessed portion; and (b-3) a projecting portion which projects from the wall surface toward the opening of the axial hole and which has a distal end located inside the axial hole, and wherein the bearing, the wall surface defining the recessed portion and the projecting portion cooperate to surround a surrounded space that communicates with the opening of the axial hole.

According to a second aspect of the invention, in the vehicle driving apparatus according to the first aspect of the invention, the opening of the axial hole of the rotary shaft is provided with an annular protrusion that protrudes from an inner circumferential surface of the axial hole toward an inner peripheral side of the axial hole.

According to a third aspect of the invention, in the vehicle driving apparatus according to the first or second aspect of the invention, in a cross section taken in a plane containing an axis of the rotary shaft and a vertical line, two gaps are defined between the projecting portion and an inner circumferential surface of the axial hole, such that the two gaps consist of a first gap and a second gap that is located on a lower side of the first gap in a direction of the vertical line, wherein the first gap is wider than the second gap. It is noted that the above-described cross section may be defined also as a cross section taken in a plane containing the axis of the rotary shaft and an orthogonal line which is orthogonal to the axis and which passes through the oil hole, and the second gap may be defined also to be more distant from the oil hole than the first gap in a direction of the orthogonal line.

According to a fourth aspect of the invention, in the vehicle driving apparatus according to any one of the first through third aspects of the invention, the casing defines therein a gear room and a motor room that are adjacent to each other, such that the rotary shaft is disposed in the gear room while a motor is disposed in the motor room, wherein the casing has a partition wall by which the gear room and the motor room are separated from each other, wherein the rotary shaft passes through a through-hole provided in the partition wall, such that another axial end of the rotary shaft is located in the motor room, and wherein the axial hole of the rotary shaft passes through the rotary shaft in the axial direction.

According to a fifth aspect of the invention, in the vehicle driving apparatus according to the fourth aspect of the invention, there is provided a second bearing in addition to the bearing as a first bearing, such that a rotor shaft of the motor is rotatably supported by the second bearing, wherein the rotary shaft is engaged at the other axial end with an axial end of the rotor shaft of the motor, wherein the rotor shaft has an axial hole passing through the rotor shaft in an axial direction of the rotor shaft and communicating with the axial hole of the rotary shaft, and wherein the axial hole of the rotor shaft has an opening in another axial end of the rotor shaft, such that the opening of the axial hole of the rotor shaft communicates with a space in which the second bearing is disposed.

In the vehicle driving apparatus according to the first aspect of the invention, the projecting portion is provided to project from the wall surface toward the opening of the axial hole and which has the distal end located inside the axial hole, so that the oil is guided on the projecting portion so as to be caused to efficiently flow into the axial hole through the opening of the axial hole. The projecting portion can be provided without increase of the number of components and without an operation for attaching the projecting portion to another portion of the vehicle driving apparatus. Thus, it is possible to efficiently supply the oil into the axial hole, even without increase of the number of components and cumbersome assembling operation.

In the vehicle driving apparatus according to the second aspect of the invention, the opening of the axial hole of the rotary shaft is provided with the annular protrusion that protrudes from the inner circumferential surface of the axial hole toward the inner peripheral side of the axial hole, so that the oil flowing into the axial hole can be suppressed from flowing out from the opening of the axial hole.

In the vehicle driving apparatus according to the third aspect of the invention, the two gaps are defined between the projecting portion and the inner circumferential surface of the axial hole, and the two gaps consist of the first gap and the second gap that is located on the lower side of the first gap in the direction of the vertical line, such that the first gap is wider than the second gap. Owing to this arrangement, it is possible to suppress the oil from flowing out from the axial hole through the second gap, and to cause the oil to efficiently flow into the axial hole.

In the vehicle driving apparatus according to the fourth aspect of the invention, although flow of the oil between the gear room and the motor room is limited by the partition wall by which the gear room and the motor room are separated from each other, the oil flowing into the axial hole of the rotary shaft can be supplied to the motor room through the axial hole of the rotary shaft, so that the oil can be supplied to components disposed in the motor room that include the motor and the bearing by which the rotor shaft of the motor is rotatably supported.

In the vehicle driving apparatus according to the fifth aspect of the invention, the oil flowing into the axial hole can be supplied to the second bearing by which the rotor shaft is rotatably supported, through the axial hole of the rotary shaft and the axial hole of the rotor shaft.

### BRIEF DESCRIPTION OF THE DRAWINGS

FIG. 1 is a cross-sectional view showing a part of a vehicle driving apparatus to which the present invention is applied; and

FIG. 2 is a cross sectional view showing, in enlargement, a part of the view of FIG. 1, specifically, around an opening of an axial hole provided in a rotary shaft of the vehicle driving apparatus.

### DETAILED DESCRIPTION OF PREFERRED EMBODIMENT

Hereinafter, a preferred embodiment of the invention will be described in detail with reference to the accompanying drawings. The figures of the drawings are simplified or deformed as needed, and each portion is not necessarily precisely depicted in terms of dimension ratio, shape, etc.

### EMBODIMENT

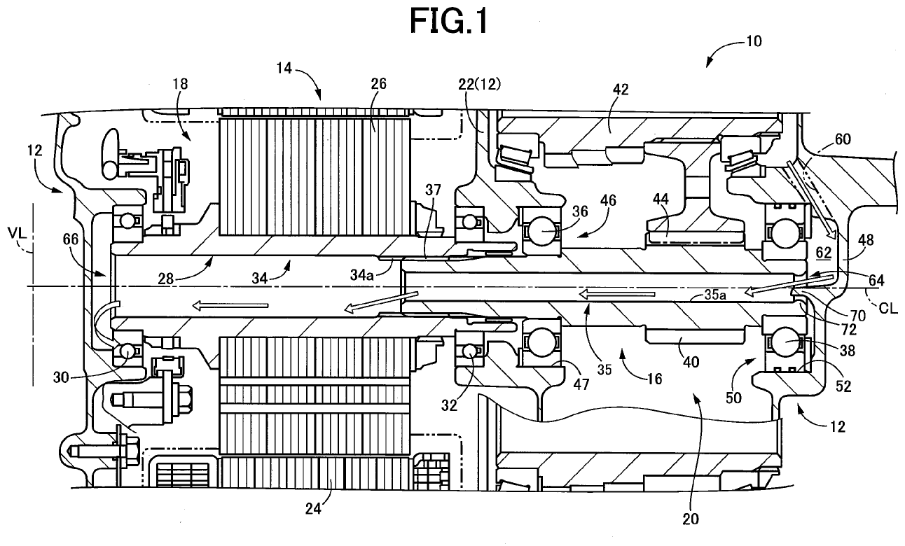

FIG. 1 is a cross-sectional view showing a part of a vehicle driving apparatus 10 to which the present invention is applied. The vehicle driving apparatus 10 includes a casing 12 as a non-rotary member, a motor 14 as a drive power source, and a rotary shaft 16 to which a power of the motor 14 is to be transmitted. The motor 14 and the rotary shaft 16 are disposed inside the casing 12, and arranged side by side in a direction of an axis CL about which the rotary shaft 16 is to be rotated. The motor 14 as well as the rotary shaft 16 is rotatable about the axis CL of the rotary shaft 16. It is noted that the cross-sectional view of FIG. 1 is taken in a plane containing the axis CL and a vertical line LV and shows the part of the vehicle driving apparatus 10 that is installed in a vehicle.

The casing 12 is a housing that stores therein the motor 14 and the rotary shaft 16. The casing 12 defines a motor room 18 and a gear room 20, such that the motor 14 is disposed in the motor room 18 while the rotary shaft 16 is disposed in the gear room 20. The motor room 18 and the gear room 20 are adjacent to each other, and are separated from each other by a partition wall 22 which is a part of the casing 12 and which extends perpendicularly to the axis CL.

The motor 14 includes a stator 24, a rotor 26 and a rotor shaft 28. The stator 24 is unrotatably fixed to the casing 12. The rotor 26 is disposed on an inner peripheral side of the stator 24. The rotor shaft 28 is disposed on an inner peripheral side of the rotor 26, and is to be rotated together with the rotor 26 about the axis CL. Each of the stator 24 and the rotor 26 is constituted by a plurality of steel plates that are laminated on each other in the direction of the axis CL. The rotor 26 is fixed onto an outer circumferential surface of the rotor shaft 28, and is unrotatable relative to the rotor shaft 28. The rotor shaft 28 is held by the casing 12 through a pair of ball bearings 30, 32, which are provided in respective end portions of the rotor shaft 28 that are opposite to each other in the direction of the axis CL, such that the rotor shaft 28 is rotatable about the axis CL. The rotor shaft 28 has an axial hole 34 passing through the rotor shaft 28 in an axial direction of the rotor shaft 28, i.e., the direction of the axis CL.

The rotary shaft 16 is a hollow shaft that has an axial hole 35 passing through the rotary shaft 16 in the direction of the axis CL. The rotary shaft 16 is held by the casing 12 through a pair of ball bearings 36, 38, such that the rotary shaft 16 is rotatable about the axis CL. The rotary shaft 16 has an axial end located in a recessed portion 50 defined by a wall portion 48 that is a part of the casing 12. The rotary shaft 16 passes through a through-hole 46 provided in the partition wall 22, such that another axial end of the rotary shaft 16 is located in the motor room 18. The through-hole 46, which is formed through the partition wall 22, communicates between the motor room 18 and the gear room 20. Further, the rotary shaft 16 has, in its axial end portion located on a side of the other end (i.e., on a side of the motor 14), external spline teeth 37 engaged with 34a that are provided in the axal hole 34 of the rotor shaft 28. Thus, the external spline teeth 37 provided in the axial end portion (located on a side of the above-described other axial end) of the rotary shaft 16 and the internal spline teeth 34a provided in an axial end portion of the rotor shaft 28 are engaged with each other, so that the rotor shaft 28 and the rotary shaft 16 are rotatable integrally with each other. The rotary shaft 16 has a drive gear 40 which is provided in its outer circumferential surface and which is located between the ball bearings 36, 38 in the direction of the axis CL. The drive gear 40 constantly meshes with a driven gear 44 provided on a counter shaft 42. It is noted that the ball bearing 38 corresponds to “bearing” recited in the appended claims.

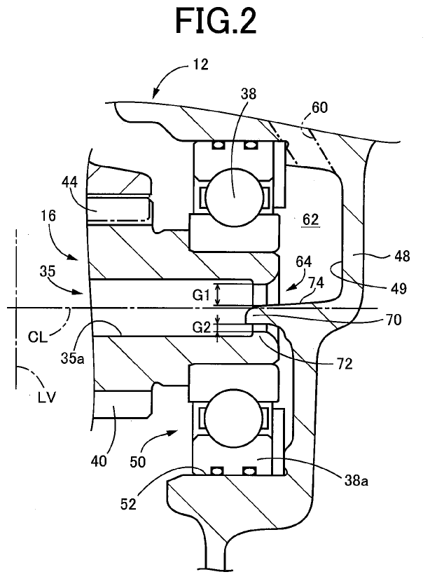

The ball bearing 36 is interposed between the outer circumferential surface of the rotary shaft 16 and an inner circumferential surface 47 of the through-hole 46 provided in the partition wall 22. The ball bearing 38 is interposed between an outer circumferential surface of an axial end portion (located on a side of the above-described axial end) of the rotary shaft 16 and an inner circumferential surface 52 of the casing 12 that defines the recessed portion 50. The wall portion 48 is adjacent to the axial end of the rotary shaft 16 in the direction of the axis CL, and includes a part substantially perpendicular to the axis CL. The wall portion 48 of the casing 12 cooperates with the inner circumferential surface 52 of the casing 12 to define the recessed portion 50 that is an annular space in which the axial end of the rotary shaft 16 and the ball bearing 38 are located. The ball bearing 38 is fitted at its outer race 38a (see FIG. 2) in the inner circumferential surface 52 that defines the recessed portion 50.

In the vehicle driving apparatus 10, an oil is released from a pipe or the like (not shown), for example, so as to be supplied to the motor 14 and various bearings. However, since flow of the oil between the motor room 18 and the gear room 20 is restricted due to presence of the partition wall 22 by which the motor room 18 and the gear room 20 are separated from each other, the oil could not be sufficiently supplied to the ball bearing 30 by which the rotor shaft 28 is rotatably supported. On the other hand, in the present embodiment, the vehicle driving apparatus 10 is provided with a lubrication mechanism 58 for supplying the oil to exclusively the ball bearing 30. The lubrication mechanism 58 includes an oil hole 60 provided in the wall portion 48 of the casing 12, an oil reservoir 62 with which the oil hole 60 communicates, the above-described axial hole 35 of the rotary shaft 16 into which the oil supplied into the oil reservoir 62 is to flow, and the axial hole 34 of the rotor shaft 28. It is noted that the ball bearing 30 corresponds to “second bearing” recited in the appended claims, and that the axial hole 34 corresponds to “axial hole (that the rotor shaft has)” recited in the appended claims.

The oil hole 60 is provided in the wall portion 48 of the casing 12, and communicates with the oil reservoir 62. To the oil hole 60, the oil discharged from, for example, an oil pump (not shown) is supplied through the pipe or the like.

The oil reservoir 62 is provided between the ball bearing 38 and the wall portion 48 in the direction of the axis CL. The oil reservoir 62 is a surrounded space surrounded by the ball bearing 38, the wall surface 49 (see FIG. 2) of the wall portion 48 defining the recessed portion 50 and a projecting portion 70 that is described below. Since the oil reservoir 62 is a part of a space providing the recessed portion 50, it can be said that the oil hole 60 communicates with the recessed portion 50. The oil reservoir 62 communicates with an opening 64 of the axial hole 35 which is located in the above-described axial end of the rotary shaft 16. The axial hole 35 passes through the rotary shaft 16 in the direction of the axis CL. Since the axial hole 34 also passes through the rotor shaft 28 in the direction of the axis CL, the axial hole 35 of the rotary shaft 16 and the axial hole 34 of the rotor shaft 28 communicate with each other. The axial hole 34 of the rotor shaft 28 has an opening 66 in another axial end of the rotor shaft 28 which is located on a side of the ball bearing 30 (by which the rotor shaft 28 is rotatably supported), and the opening 66 communicates with a space in which the ball bearing 30 is disposed. It is noted that the oil reservoir 62 corresponds to “surrounded space (surrounded by the bearing, the wall surface defining the recessed portion and the projecting portion)” that is recited in the appended claims.

Owing to the lubrication mechanism 58 constructed as described above, the oil flowing into the oil hole 60 is caused to flow into the oil reservoir 62 through the oil hole 60. Further, the oil flowing into the oil reservoir 62 is caused to flow into the axial hole 35 of the rotary shaft 16 through the opening 64 of the axial hole 35. Then, the oil flowing into the axial hole 35 is caused to flow through the axial holes 35, 34, and is caused to flow out from the opening 66 of the axial hole 34 so as to be supplied to the ball bearing 30. It is noted that white arrows indicate flow of the oil in the lubrication mechanism 58 in which the oil flowing into the oil hole 60 is eventually supplied to the ball bearing 30 so as to lubricate ball bearing 30.

In the lubrication mechanism 58, the oil flowing into the oil reservoir 62 is required to efficiently flow into the axial hole 35 of the rotary shaft 16. Conventionally, an oil guide, which is provided independently of the casing 12, is press-fitted in the casing 12, and the oil is caused to flow into the axial hole 35 through the oil guide that is press-fitted in the casing 12. However, the provision of the oil guide independent of the casing 12 leads to increase of the number of components, and requires cumbersome operation including press-fitting of the oil guide into the casing 12. For example, when the oil guide is to be press-fitted in the casing 12, the casing 12 needs to have a flat shape for holding the oil guide from a back side of the casing 12. For forming the flat shape, additional casting mould is required whereby the number of required casting moulds is increased. Further, with increase of the number of the required casting moulds, a direction of removal of each casting mould is limited and accordingly a shape of the casing 12 is limited. Consequently, ribs provided in the casing 12 could not be given suitable shapes for obtaining strength performance and NV performance.

On the other hand, in the present embodiment, the lubrication mechanism 58 has, as a structure configured to supply the oil into the opening 64 of the axial hole 35 which is located in the axial end of the rotary shaft 16, a projecting portion 70 in place of the above-described oil guide, wherein the projecting portion 70 projects from the wall surface 49 of the wall portion 48 that defines the recessed portion 50 in the casing 12, toward the opening 64 of the axial hole 35 in the direction of the axis CL, such that a distal end of the projecting portion 70 is located inside the axial hole 35. The projecting portion 70 is formed integrally with the casing 12, for example, by die-casting using aluminum alloy.

FIG. 2 is a cross sectional view showing, in enlargement, a part of the view of FIG. 1, specifically, around the opening 64 of the axial hole 35. As shown in FIG. 2, the projecting portion 70 projects from the wall surface 49 of the wall portion 48 toward the opening 64 of the axial hole 35 of the rotary shaft 16 in the direction of the axis CL, and is introduced through the opening 64 into the axial hole 35, so that the distal end of the projecting portion 70 is located inside the axial hole 35. Therefore, the distal end of the projecting portion 70 overlaps with the rotary shaft 16 as viewed in a radial direction of the rotary shaft 16. The projecting portion 70 has a tapered surface 74 that is inclined in a downward direction, i.e., in a vertical direction away from the oil hole 60, as viewed in a direction toward the distal end away from a proximal end of the projecting portion 70. The projecting portion 70 has, in its cross section, substantially a U-shaped, i.e., a gutter shape, as viewed in the direction of the axis CL, so that the oil flowing into the oil reservoir 62 is guided on the tapered surface 74 of the projecting portion 70 so as to be caused to efficiently flow into axial hole 35 from the distal end of the projecting portion 70.

Further, the opening 64 of the axial hole 35 of the rotary shaft 16, which is located on a side of the ball bearing 38 in the direction of the axis CL, is provided with an annular protrusion 72 that protrudes radially from an inner circumferential surface 35a of the axial hole 35 toward an inner peripheral side of the axial hole 35. Owing to provision of the annular protrusion 72, the oil flowing into the axial hole 35 through the projecting portion 70 is suppressed from flowing out from the opening 64 of the axial hole 35. It is noted that a radial height of the annular protrusion 72 is determined by experimentation or an appropriate design theory, such that the radial height is set to a value that makes it possible to appropriately suppress the oil from flowing out from the opening 64.

Further, in the cross section shown in the cross-sectional view of FIG. 2, which is taken in a plane containing the axis CL of the rotary shaft 16 and the vertical line LV (i.e., an orthogonal line which is orthogonal to the axis CL and which passes through the oil hole 60), two gaps G1, G2 are defined between the projecting portion 70 and the inner circumferential surface 35a of the axial hole 35, such that the two gaps G1, G2 consist of a first gap G1 and a second gap G2 that is located on a lower side of the first gap G1 in a direction of the vertical line LV, namely, that is more distant from the oil hole 60 than the first gap G1 in a direction of the orthogonal line, wherein the first gap G1 is wider than the second gap G2. Owing to this arrangement, it is possible to suppress the oil from flowing out from the axial hole 35 through the second gap G2.

Owing to the lubrication mechanism 58 constructed as described above, the oil flowing into the oil reservoir 62 through the oil hole 60 is guided on the tapered surface 74 of the projecting portion 70 so as to be moved to the distal end of the projecting portion 70, and is caused to efficiently flow into the axial hole 35 of the rotary shaft 16 from the distal end of the projecting portion 70. Further, since the oil flowing into the axial hole 35 is suppressed by the annular protrusion 72 from flowing out through the opening 64, the oil can be efficiently supplied to the ball bearing 30 via the axial hole 35 of the rotary shaft 16 and the axial hole 34 of the rotor shaft 28.

Since the projecting portion 70 is formed integrally with the casing 12 by casting, the number of the required components can be made smaller than in the arrangement in which the oil guide is additionally provided to guide the oil into the axial hole 35. Further, since the oil guide does not need to be press-fitted in the casing 12, the casing 12 does not need to have a flat shape, which would be required for holding the oil guide from the back side of the casing 12 when the oil guide is to be press-fitted in the casing 12. In connection with this, additional casting mould for exclusively forming the flat shape is not required so that the number of required casting moulds is not increased and accordingly a direction of removal of each casting mould is not limited due to the increase of the number of required casting moulds. Consequently, a degree of freedom in the shape of the casing 12 is increased whereby ribs provided in the casing 12 can be given suitable shapes for obtaining strength performance and NV performance.

As described above, in the present embodiment, the projecting portion 70 is provided to project from the wall surface 49 of the wall portion 48 of the casing 12 toward the opening 64 of the axial hole 35 and which has the distal end located inside the axial hole 35, so that the oil is guided on the projecting portion 70 so as to be caused to efficiently flow into the axial hole 35 through the opening 64 of the axial hole 35. The projecting portion 70 can be provided without increase of the number of components and without an operation for attaching the projecting portion 70 to another portion of the vehicle driving apparatus 10. Thus, it is possible to efficiently supply the oil into the axial hole 35, even without increase of the number of components and cumbersome assembling operation.

In the present embodiment, the opening 64 of the axial hole 35 of the rotary shaft 16 is provided with the annular protrusion 72 that protrudes from the inner circumferential surface 35a of the axial hole 35 toward the inner peripheral side of the axial hole 35, so that the oil flowing into the axial hole 35 can be suppressed from flowing out from the opening 64 of the axial hole 35. Further, the two gaps G1, G2 are defined between the projecting portion 70 and the inner circumferential surface 35a of the axial hole 35, and the two gaps G1, G2 consist of the first gap G1 and the second gap G2 that is located on the lower side of the first gap G1 in the direction of the vertical line, such that the first gap G1 is wider than the second gap G2. Owing to this arrangement, it is possible to suppress the oil from flowing out from the axial hole 35 through the second gap G2, and to cause the oil to efficiently flow into the axial hole 35. Further, although flow of the oil between the gear room 20 and the motor room 18 is limited by the partition wall 22 by which the gear room 20 and the motor room 18 are separated from each other, the oil flowing into the axial hole 35 of the rotary shaft 16 can be supplied to the motor room 18 through the axial hole 35 of the rotary shaft 16, so that the oil can be supplied to components disposed in the motor room 18. Further, the oil flowing into the axial hole 35 of the rotary shaft 16 can be supplied to the ball bearing 30 by which the rotor shaft 28 is rotatably supported, through the axial hole 35 of the rotary shaft 16 and the axial hole 34 of the rotor shaft 28.

While the preferred embodiment of this invention has been described in detail by reference to the drawings, it is to be understood that the invention may be otherwise embodied.

For example, in the above-described embodiment, the axial hole 35 of the rotary shaft 16 is a through-hole passing through the rotary shaft 16 in the axial direction. However, the axial hole 35 does not necessarily have to be the through-hole but may be a blind hole extending from the axial end of the rotary shaft 16 to a predetermined axial depth. Where the axial hole 35 extends from the axial end of the rotary shaft 16 to the predetermined axial depth, a radial hole or holes may be provided in the rotary shaft 16 to communicate with the axial hole 35, so that the oil flowing into the axial hole 35 is caused to flow out from the rotary shaft 16 through the radial hole or holes, and is then supplied to a member provided radially outside the rotary shaft 16.

In the above-described embodiment, the oil flowing into the axial hole 35 of the rotary shaft 16 is supplied to the ball bearing 30 via the axial hole 34 of the rotor shaft 28. However, the oil flowing into the axial hole 35 of the rotary shaft 16 does not necessarily have to be supplied to the ball bearing 30 but may be supplied to any part that needs to be lubricated or cooled by the oil. Further, the oil flowing into the axial hole 35 does not necessarily have to be supplied to the motor room 18 but may be supplied to any member disposed in the gear room 20.

In the above-described embodiment, the rotary shaft 16 is rotatably held by the casing 12 through the ball bearings 36, 38. However, each of the ball bearings 36, 38 may be replaced by a roller bearing, for example. Further, the rotor shaft 28 is rotatably held by the casing 12 through the ball bearings 30, 32. However, each of the ball bearings 30, 32 may be replaced by a roller bearing, for example.

It is to be understood that the embodiment described above is given for illustrative purpose only, and that the present invention may be embodied with various modifications and improvements which may occur to those skilled in the art.

### NOMENCLATURE OF ELEMENTS

10: vehicle driving apparatus
12: casing
14: motor
16: rotary shaft
18: motor room
20: gear room
22: partition wall
28: rotor shaft
30: ball bearing (second bearing)
34: axial hole
35: axial hole
38: ball bearing (first bearing)
46: through-hole
49: wall surface
50: recessed portion
58: lubrication mechanism
60: oil hole
62: oil reservoir (surrounded space surrounded by bearing, wall surface defining recessed portion and projecting portion)
64: opening
70: projecting portion
72: annular protrusion
G1: first gap (gap)
G2: second gap (gap)

What is claimed is:

1. A vehicle driving apparatus comprising:
a rotary shaft having an axial hole which has an opening in an axial end of the rotary shaft, and which extends from the axial end of the rotary shaft in an axial direction of the rotary shaft;
a casing storing the rotary shaft therein;
a bearing provided between the casing and an outer circumferential surface of the rotary shaft so as to rotatably support the rotary shaft; and
a lubrication mechanism having a structure configured to supply an oil into the opening of the axial hole,
wherein the casing is provided with:
a recessed portion that is an annular space defined by a wall surface of the casing and located on a side of the axial end of the rotary shaft, such that the axial end of the rotary shaft and the bearing are located in the recessed portion;
an oil hole communicating with the recessed portion; and
a projecting portion which projects from the wall surface toward the opening of the axial hole and which has a distal end located inside the axial hole, and wherein the bearing, the wall surface defining the recessed portion and the projecting portion cooperate to surround a surrounded space that communicates with the opening of the axial hole.

2. The vehicle driving apparatus according to claim 1,
wherein the opening of the axial hole of the rotary shaft is provided with an annular protrusion that protrudes from an inner circumferential surface of the axial hole toward an inner peripheral side of the axial hole.

3. The vehicle driving apparatus according to claim 1,
wherein, in a cross section taken in a plane containing an axis of the rotary shaft and a vertical line, two gaps are defined between the projecting portion and an inner circumferential surface of the axial hole, such that the two gaps consist of a first gap and a second gap that is located on a lower side of the first gap in a direction of the vertical line, and
wherein the first gap is wider than the second gap.

4. The vehicle driving apparatus according to claim 1,
wherein the casing defines therein a gear room and a motor room that are adjacent to each other, such that the rotary shaft is disposed in the gear room while a motor is disposed in the motor room,
wherein the casing has a partition wall by which the gear room and the motor room are separated from each other,
wherein the rotary shaft passes through a through-hole provided in the partition wall, such that another axial end of the rotary shaft is located in the motor room, and
wherein the axial hole of the rotary shaft passes through the rotary shaft in the axial direction.

5. The vehicle driving apparatus according to claim 4, comprising a second bearing in addition to the bearing as a first bearing, such that a rotor shaft of the motor is rotatably supported by the second bearing,
wherein the rotary shaft is engaged at the other axial end with an axial end of the rotor shaft of the motor,
wherein the rotor shaft has an axial hole passing through the rotor shaft in an axial direction of the rotor shaft and communicating with the axial hole of the rotary shaft, and
wherein the axial hole of the rotor shaft has an opening in another axial end of the rotor shaft, such that the opening of the axial hole of the rotor shaft communicates with a space in which the second bearing is disposed.

6. The vehicle driving apparatus according to claim 1,
wherein, in a cross section taken in a plane containing an axis of the rotary shaft and an orthogonal line which is orthogonal to the axis and which passes through the oil hole, two gaps are defined between the projecting portion and an inner circumferential surface of the axial hole, such that the two gaps consist of a first gap and a second gap that is more distant from the oil hole than the first gap in a direction of the orthogonal line, and
wherein the first gap is wider than the second gap.
